(19) United States
(12) Patent Application Publication
(10) Pub. No.: US 2010/0270986 A1
(43) Pub. Date: Oct. 28, 2010

(54) HIGH EFFICIENCY POWER CONVERTER, AND MODULATOR AND TRANSMITTER USING IT

(75) Inventor: Alssandro Alimenti, Pomezia (Roma) (IT)

Correspondence Address: SEED INTELLECTUAL PROPERTY LAW GROUP PLLC, 701 FIFTH AVE, SUITE 5400, SEATTLE, WA, 98104, US

(73) Assignee: SELEX COMMUNICATIONS S.P.A., Genova (IT)

(21) Appl. No.: 11/917,146

(22) PCT Filed: Jun. 8, 2006
(86) PCT No.: PCT/IB06/51827

§ 371 Date: Jun. 29, 2010

(30) Foreign Application Priority Data
Jun. 10, 2005 (IT) TO2005A000402

(51) Int. Cl. G05F 1/10

(52) U.S. Cl. 323/282

(57) ABSTRACT

A power converter is described adapted to be connected to an electrical power source, in particular a voltage source (V_{cc}), and intended to receive at the input a control signal (A(t)) for the conversion, including a first regulator circuit (L₁, C₁, M₁, D₁) of the pulse width modulation step-down type and an energy recovery-circuit for managing a bidirectional flow of energy from the source to the load and from the load to the source; such an energy recovery circuit may advantageously be implemented using a second regulator circuit (L₂, M₂, D₂) of the pulse width modulation step-up type.

The present invention relates to a power converter according to the preamble of Claim 1.

Such a converter is typically applied to amplitude modulators for radio transmitters and the present invention also relates to an amplitude modulator and a radio transmitter.

In general, such a converter can be applied, for example, when it is necessary to adjust or convert power in an efficient manner and controlled by an analogue or a digital signal.

To produce a radio transmitter capable of performing each type of modulation (analogue and/or digital), the typical approach is to use a low I-Q level (Cartesian) modulator followed by class A radiofrequency amplifiers; in this manner, high efficiency is not achieved; indeed the typical efficiency of such a solution is less than 50%.

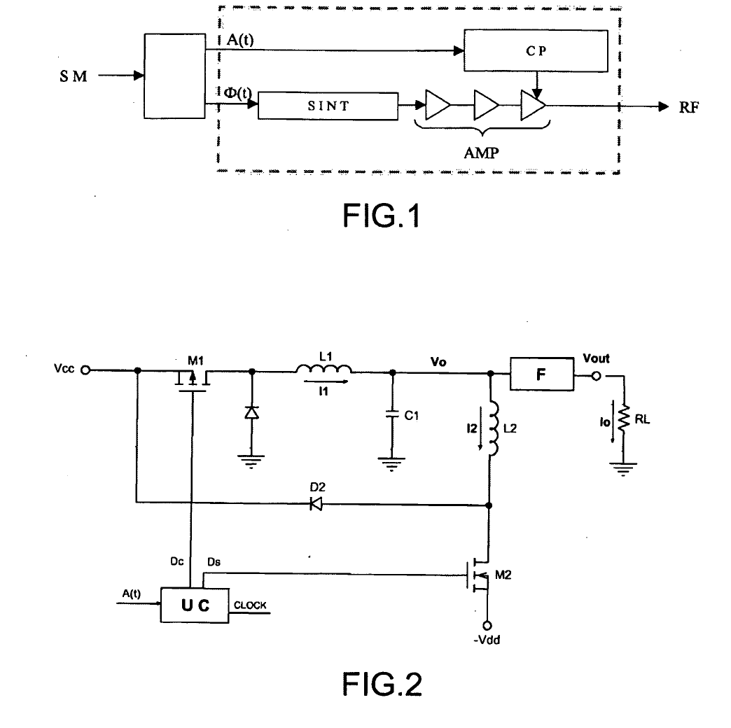

This problem can be solved using a polar modulator (Envelope Elimination and Restoration), as shown schematically in FIG. 1, which receives at its input a modulating signal SM, split up into the amplitude A(t) of the modulating signal and the phase Φ(t) of the modulating signal via, for example, a DSP processor, and which delivers at its output an amplitude-modulated radiofrequency signal RF, i.e. X(t)=A(t)·cos(ω₀t+φ(t)); the polar modulator of FIG. 1 has:
phase modulation carried out according to a synthesizer SYNT,
amplification of the signal generated by the synthesizer SYNT using a chain of radiofrequency power amplifiers AMP in a saturated class (class AB, B, C, D, E or F) to achieve high efficiency at radiofrequency,
envelope, i.e. amplitude, modulation introduced through a power converter CP in the final radiofrequency amplifier stage by varying its supply voltage.

The envelope modulator manages almost all the power absorbed by the transmitter; it is therefore important that its efficiency be very high. Furthermore, the envelope modulator must supply, to the final amplifier stage, a variable voltage having the dynamic range set by the modulating signal A(t).

Achieving amplitude modulation by varying the supply voltage of the final amplifier stage has been known for at least 70 years, often referred to as “plate modulation”, and was achieved using a modulation transformer (see, for example, “Radio Engineers Handbook”, McGraw Hill, 1943).

The possibility of implementing the amplitude modulator by means of a step-down pulse width modulation regulator, i.e. a “PWM regulator”, thereby eliminating the modulation transformer, was introduced at around the end of the 1960s. Today, it is well known both in scientific literature (see, for example, “Polar Modulation-Based RF Power Amplifiers with Enhanced Envelope Processing Technique” by J. K. Jau, F. Y. Han, M. C. Du, T. S. Horng, T. C. Lin at the 34th European Microwave Conference, Amsterdam, 2004) and in patent documentation (see, for example, patents U.S. Pat. No. 3,413,570, U.S. Pat. No. 3,506,920, U.S. Pat. No. 3,588,744, U.S. Pat. No. 4,896,372).

In general, the approach proposed in such literature is always that of a step-down regulator that drives a radiofrequency power amplifier in class AB, B, C, D, E or F or other “saturated” classes, by varying its supply voltage.

A further advancement was proposed in 1999 by patent U.S. Pat. No. 6,636,112 in which there is added in cascade with the step-down PWM regulator a linear regulator having a dual functionality:
a) to follow the quicker dynamics of the signal, making up for the problems inherent in the PWM regulator and described later in the present document,
b) to reduce the noise introduced by the switching in the PWM regulator that normally gives rise to spurious components in the transmitted signal (see patent U.S. Pat. No. 6,636,112 at column 8, lines 34 to 39).

Such a linear regulator reduces the overall efficiency of the system since, by its nature, it dissipates some of the energy supplied by the PWM regulator (see patent U.S. Pat. No. 6,636,112 at column 9, lines 7 to 13).

In patent U.S. Pat. No. 6,636,112 (see at column 8, lines 1 to 14) it is assumed that the resistance exhibited by the final stage at its supply port is constant.

The general aim of the present invention is to eliminate or reduce the drawbacks of the prior art.

This aim is achieved by the power converter having the characteristics indicated in the accompanying claims which are to be considered an integral part of the present description.

The present invention is based on the idea of recovering excess energy accumulated at the output using a suitable circuit and, in particular, transferring it to the input.

A further innovative aspect of the present invention can be appreciated by considering that which is asserted in patent U.S. Pat. No. 6,636,112 at column 8, lines 1 to 14, where it is assumed that the resistance exhibited by the final stage at its supply port is constant. Such an affirmation is true only in the presence of perfectly matched loads and is fundamental in the abovementioned patent to succeed in calculating, independently of everything, the voltage to be applied to the final stage in order to have the desired power. In the solution proposed by the present invention there is no such constraint; the control method allows to calculate (cycle by cycle) the duty cycle to be realized (in order to produce the voltage to be applied to the final stage) even in the presence of a power amplifier whose resistance exhibited at the supply port is variable. The true resistance of the power amplifier can therefore be measured (cycle by cycle) and this value (or an average value thereof) can be used at the next cycle.

With the present invention (by virtue also of the original control method), highly unmatched or variable loads may therefore also be accommodated.

The invention will now be better explained with the aid of the accompanying drawings, which however are intended only as explanatory and non-limiting examples, in which:

FIG. 1 shows a block diagram of an amplitude modulation transmitter,

FIG. 2 shows a simplified diagram of a first example embodiment of the converter according to the present invention,

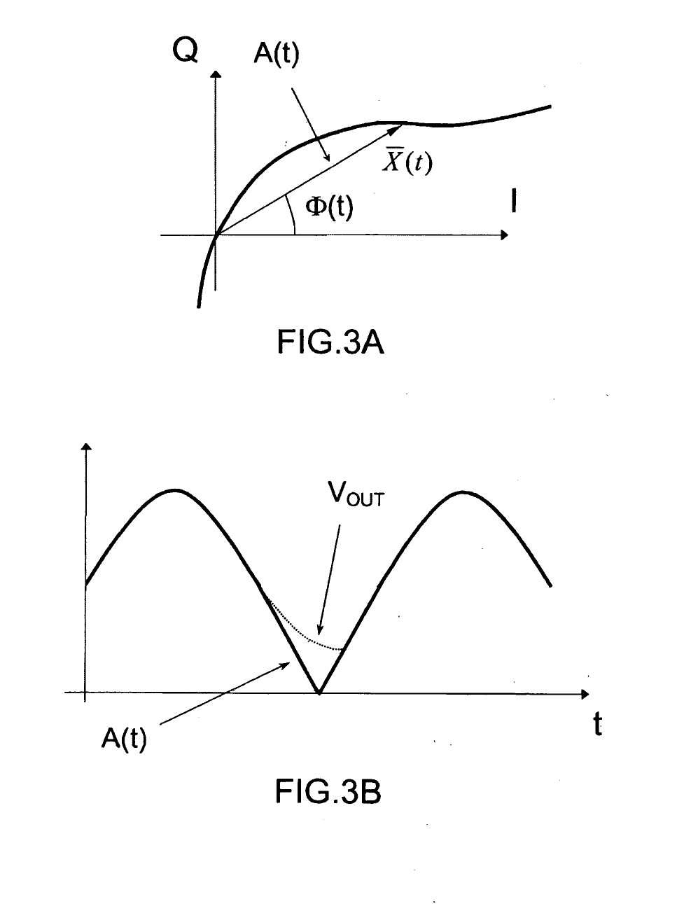

FIG. 3A shows the possible path of a phasor on the I-Q plane,

FIG. 3B shows how the amplitude of the phasor of FIG. 3A varies with time and the corresponding output voltage of a converter,

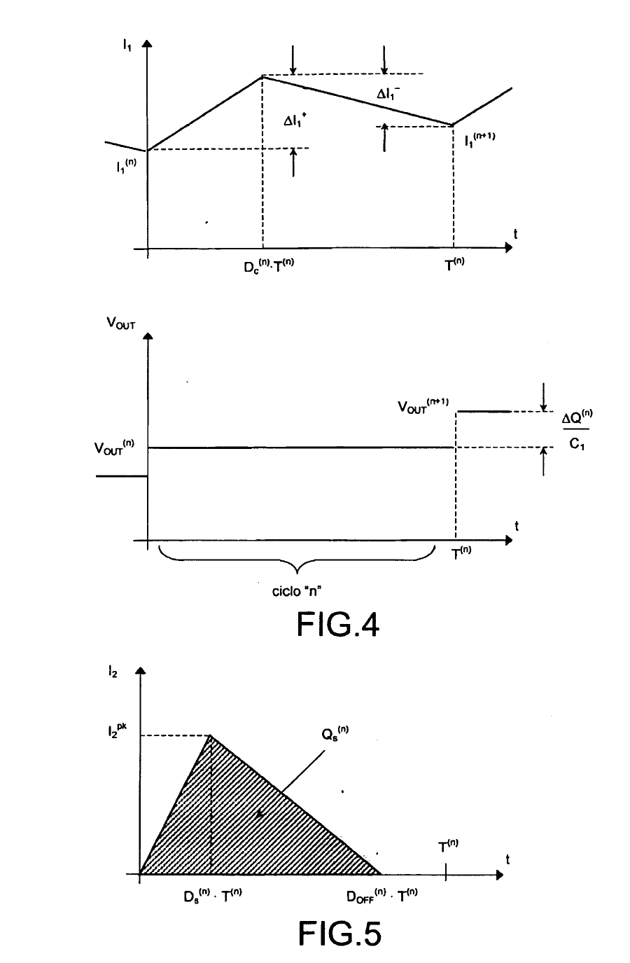

FIG. 4 shows how the current I₁ varies according to formula [3], and how the voltage Vₒᵤₜ varies according to the second assumption on which the analytical model of the present invention is based and in light of formula [4],

FIG. 5 shows a possible manner in which the current I₂ can vary and the associated integral Q_{S} calculated according to formula [19],

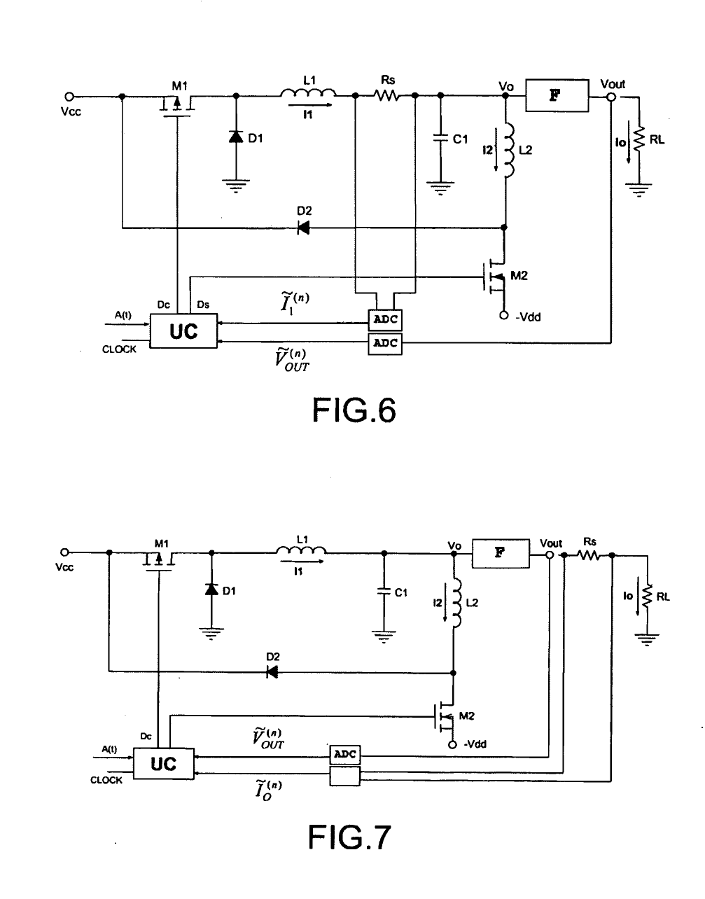

FIG. 6 shows a simplified diagram of a second example embodiment of the converter according to the present invention, and

FIG. 7 shows a simplified diagram of a third example embodiment of the converter according to the present invention.

To achieve high efficiency, the converter according to the present invention employs the pulse width modulation, or PWM, technique as shown in FIG. 2, FIG. 6 and FIG. 7.

One of the innovative aspects of the present invention is the combining of two different PWM regulators: the first, made up of an inductor L₁, a capacitor C₁, a transistor M₁ and a diode D₁, is a step-down regulator and manages the flow of power from the main electrical power source, i.e. the positive voltage source V_{cc}, to the load R_{L}, assumed to be substantially resistive; the second, made up of an inductor L₂, a transistor M₂ and a diode D₂, is a step-up regulator and provides a fast discharge of the circuit components L₁ and C₁ i.e. the two components of the first regulator that store energy.

In other words the step-up regulator is capable of transferring, without dissipating, energy from the circuit components L₁ and C₁ to the main source V_{cc}. To do this sufficiently fast, a secondary electrical power source is preferably used, i.e. the negative voltage source V_{dd}.

Naturally, the two PWM regulators and their switching circuit components M₁ and M₂ are controlled by an appropriate control unit, indicated UC in FIG. 2, FIG. 6 and FIG. 7; the component M₁ is driven by a switching signal with a duty cycle D_{c} and the component M₂ is driven by a switching signal with a duty cycle Dₛ.

As regards the switching circuit components, by appropriately choosing the control driver, the transistors M₁ and M₂ may be N-channel or P-channel MOSFETs, independently of each other, or other types of transistors.

As regards the diodes D₁ and D₂, these may be PN junction or Schottky diodes. Furthermore, these diodes could be replaced or put together with transistors, for example, of the MOSFET type suitably driven so as to have a very limited voltage drop across these circuit components during the conduction phases; this contributes to further increasing the efficiency.

The main generator V_{cc} must be designed to supply all the power required by the final radiofrequency amplifier stage.

The step-down regulator, controlled by the signal with duty cycle D_{c}, transfers power to the output by allowing the output voltage V_{OUT} to vary, as required according to the modulating signal A(t).

The steady-state response of a step-down regulator is:

V_{OUT}=V_{cc}·D_{c} [1]

where:
V_{cc}=voltage of the main source;
V_{OUT}ε[0, V_{cc}]=output voltage;
D_{c}ε[0,1]=duty cycle.

The dynamic response is different; this is due to two different physical phenomena:
the low-pass linear response of the components L₁, C₁, R_{L};
the non-linear response due to the topology of the circuit components M₁ and D₁ which allows current to flow from V_{cc} to V_{OUT} but not vice versa.

The linear behaviour of the step-down regulator can be compensated for by acting on the duty cycle D_{c} of the signal driving the transistor M₁.

The step-down regulator exhibits its non-linear behaviour when a steep negative slope is required for the output voltage V_{OUT}; in that case neither the transistor M₁ nor the diode D₁ is capable of removing energy from the inductor L₁ and the capacitor C₁, and the output voltage falls according to the law R_{L}−C₁/L₁.

With reference to FIG. 3B, it is possible to show that the non-linear distortion starts when the (negative) slope of the desired output voltage exceeds the relaxation time of the circuits L₁, C₁, R_{L}.

$${\frac{d {V}_{OUT}}{d t} \vert}_{t = 0} = - \frac{{V}_{( 0 )}}{{R}_{L} \cdot {C}_{1}} + \frac{{I}_{( 0 )}}{{C}_{1}} \qquad [ 2 ]$$

The direct consequence of formula [2] is that the maximum allowable slope tends to zero with the output voltage V₀. If the voltage V₀ is close to zero, the output resistance R_{L} is not able to quickly discharge the capacitor C₁ and as a result the voltage V_{OUT} will turn out to have a (negative) derivative close to zero.

This result shows the main problem related to the step-down topology: the circuit cannot reproduce waveforms with cusps down to zero.

A typical example is indicated in FIG. 3; in particular FIG. 3A shows the path of a phasor X̅(t) of modulus A(t) and phase Φ(t) which, on the I-Q plane, passes through the origin of the axes; trajectories of this type are common in many modulation schemes (such as QAM, SSB, DSB or others). FIG. 3B shows the corresponding variation of the amplitude A(t) of the phasor X̅(t) and of the actual output voltage V_{OUT}; close to the cusp, the output resistance R_{L} is not able to discharge the capacitor C₁ quickly enough and, as a result, V_{OUT} strays from A(t).

The step-up regulator has been included to solve this specific problem. This second regulator, driven by a signal with duty cycle Dₛ, is for reversing the direction of flow of energy: from the output, or better still from the components L₁ and C₁, to the main source V_{cc}.

The step-up regulator uses a supporting negative voltage source V_{dd} to increase the speed of discharge of the output circuit. Thus, this modulator can follow both the fast dynamics of the modulating signal and the passage through zero, and the approaching to zero with non-zero derivative of the modulating signal.

Furthermore, the step-up regulator, by enabling excess energy at the output to be removed by transferring it to the main generator V_{cc}, keeps the overall efficiency high.

The use of step-down and step-up PWM regulators to vary the voltage V_{OUT} results in high efficiency and high dynamics but introduces noise at the switching frequency and at its harmonics. This noise can be seen by the presence of spurious components in the amplitude modulation (at the switching frequency and at its harmonics) with possible problems in terms of “adjacent-channel noise”.

The switching frequency must be (according to the Nyquist theorem) at least twice the maximum bandwidth of the modulating signal; the result is that the problem of transmission of spurious components does not affect the in-band signal but rather the adjacent channels.

To solve this problem, the present invention considers two different approaches.

The first approach consists in removing the unwanted frequencies (the switching frequency f_{sw} and its harmonics 2 f_{sw}, 3 f_{sw}, . . . ) using a multiple notch filter.

The variation in phase introduced by this filter, at the envelope frequencies of the modulator, will be considered as part of the total phase lag between A(t) and V_{OUT}.

The notch filter will have a structure that minimizes the equivalent capacitance in relation to ground, since it will be added to the capacitance of the capacitor C₁, and it is the main component responsible for the non-linear distortions previously described.

In FIG. 2, FIG. 6 and FIG. 7, the multiple notch filter is labelled F.

The second approach consists in spreading the unwanted frequencies by applying a random and variable time-domain jitter to the switching and therefore causing the duration T of the switching period to vary slightly and continuously in a random manner.

This solution, simple from the circuit point of view, increases the complexity of the control unit UC (see FIG. 2, FIG. 6 and FIG. 7) not only through the introduction of a random generator but also because in the control algorithm formulae the duration of the switching period becomes a variable.

It is to be noted that these two approaches may advantageously be used in combination.

From the control point of view, the system can be considered as having two inputs, i.e. the duty cycles D_{c} and Dₛ, and one output, i.e. the output voltage V_{OUT}. An analytical model has therefore been developed intended to be used for a digital electronic control.

This model calculates the value of the output voltage V_{OUT} as a function of the duty cycle D_{c} at the end of each switching cycle. This model can easily be inverted, providing the duty cycle D_{c} as a function of the output voltage V_{OUT}. The acceptable range of values for D_{c} is between 0 and 1; if the calculated value of D_{c} is less than zero, the algorithm calculates the duty cycle Dₛ, which ensures the desired output voltage.

With reference to FIG. 2, the following six assumptions are made.

According to the first assumption, the voltage V₀ across the capacitor C₁ is equal to the output voltage V_{OUT} in the band of A(t). Such an assumption is justified by the notch structure of the output filter which therefore does not substantially attenuate signals in the band of the modulating signal.

According to the second assumption, the voltage V₀ across the capacitor C₁ is constant during each switching cycle.

According to the third assumption, the power amplifier is modelled as a resistor of value R_{L}. In the disclosure that follows, the resistance R_{L} will be assumed to be constant in each switching cycle. If therefore the power amplifier is modelled with a characteristic R_{L}=R_{L} (V_{OUT}), possible non-linear behaviour of the amplifier may also be taken into account in the model. In that case, the following expression can be used: R_{L}⁽ⁿ⁾=R_{L}(V_{OUT}⁽ⁿ⁾).

According to the fourth assumption, the threshold voltage of the diode D₁ and the diode D₂ is assumed to be zero.

According to the fifth assumption, the current I₂ that flows through the inductor L₂ is zero at the end of each switching cycle. This choice has been made by considering that the energy flow is mainly directed from the source V_{cc} to the load R_{L} and only in some particular cases in the reverse direction.

Thus two advantages arise.

The first advantage is related to the fact that there would only be two (instead of three) state variables for the system, since two are the components that store energy from one cycle to the next, namely the inductor L₁ and the capacitor C₁.

The second advantage is related to the fact that energy loops are thus avoided by design. In other words, the undesired condition in which energy is taken from the source V_{cc}, transferred to the output (by the step-down regulator) and then returned (by the step-up regulator) to the source V_{cc} never arises.

According to the sixth assumption, the variation in the duty cycle D_{c} from one switching cycle to the next is small compared with the said duty cycle.

The model uses two relationships:
the continuity of the current I₁ through the inductor L₁, represented by formula [3] below, and
the preservation of the charge on the capacitor C₁, represented by formula [4] below.

$$\begin{matrix}{I}_{1}^{( n + 1 )} = {I}_{1}^{( n )} + Δ {I}_{1}^{+} - Δ {I}_{1}^{-} & [ 3 ] \\ {V}_{OUT}^{( n + 1 )} = {V}_{OUT}^{( n )} + \frac{Δ {Q}^{( n )}}{{C}_{1}} & [ 4 ]\end{matrix}$$

FIG. 4 shows how the current I₁ varies and how the voltage Vₒᵤₜ varies, according to the assumption made.

By substituting in formulae [3] and [4] the following formulae [5], [6] and [7]:

$$\begin{matrix} Δ {I}_{1}^{+} = \frac{{V}_{cc} - {V}_{OUT}^{( n )}}{{L}_{1}} {D}_{c}^{( n )} \cdot {T}^{( n )} & [ 5 ] \\ Δ {I}_{1}^{-} = \frac{{V}_{OUT}^{( n )}}{{L}_{1}} ( 1 - {D}_{c}^{( n )} ) \cdot {T}^{( n )} & [ 6 ] \\ Δ {Q}^{( n )} = ( {I}_{1}^{( n )} - {I}_{0}^{( n )} ) \cdot {T}^{( n )} + \frac{{D}_{c}^{( n )} \cdot {T}^{( n )}}{2} Δ {I}_{1}^{+} + \frac{( 1 - {D}_{c}^{( n )} ) \cdot {T}^{( n )}}{2} ( 2 \cdot Δ {I}_{1}^{+} - Δ {I}_{1}^{-} ) & [ 7 ]\end{matrix}$$

where

$${I}_{0}^{( n )} = \frac{{V}_{OUT}^{( n )}}{{R}_{L}} ,$$

the following formulae [8] and [9] are obtained:

$$\begin{matrix} {I}_{1}^{( n + 1 )} = {I}_{1}^{( n )} + \frac{{V}_{cc} \cdot {T}^{( n )}}{{L}_{1}} \cdot {D}_{c}^{( n )} - \frac{{V}_{OUT}^{( n )}}{{L}_{1}} \cdot {T}^{( n )} & [ 8 ] \\ {V}_{OUT}^{( n + 1 )} = {V}_{OUT}^{( n )} \cdot [ 1 - \frac{{T}^{( n )}}{{R}_{L} \cdot {C}_{1}} - \frac{{( {T}^{( n )} )}^{2}}{2 \cdot {L}_{1} \cdot {C}_{1}} ] + \frac{{V}_{cc} \cdot {( {T}^{( n )} )}^{2}}{{L}_{1} \cdot {C}_{1}} \cdot {D}_{c}^{( n )} ( 1 - \frac{{D}_{c}^{( n )}}{2} ) + {I}_{1}^{( n )} \cdot \frac{{T}^{( n )}}{{C}_{1}} & [ 9 ]\end{matrix}$$

Formulae [8] and [9] represent a simplified, but very effective, model of the step-down PWM regulator and allow to calculate the voltage V₀ across the capacitor C₁ (which corresponds to the output voltage V_{OUT}) and the current I₁ flowing through the inductor L₁ at cycle “n+1” on the basis of the values of the current I₁, voltage V_{OUT}, duty cycle D_{c} and duration T of the switching period at cycle “n”.

Based on this analytical model, effective control methods can be implemented for controlling the switching components of the PWM regulators included in the power converter according to the present invention.

A first control method is based purely on the analytical model of formulae [8] and [9]; the simplified diagram of the associated converter is shown in FIG. 2.

The problem that needs to be solved is to calculate which duty cycle D_{c} has to be applied to cycle “n” (D_{c}⁽ⁿ⁾ in FIG. 4), with V_{OUT}⁽ⁿ⁺¹⁾ (new target voltage), V_{OUT}⁽ⁿ⁾ and I₁⁽ⁿ⁾ (present values of the two state variables of the system), and T⁽ⁿ⁾ being known.

Therefore formula [9] needs to be processed, expressing the duty cycle D_{c} as a function of all the remainder. The problem is the non-linearity of formula [9] with respect to the duty cycle D_{c}.

Rather than solving a quadratic equation, with complicated processing and which would require a complex logic circuit, the sixth assumption mentioned previously is exploited together with the fact that the variation in the term (1−D_{c}⁽ⁿ⁾/2) is definitely less than the variation in D_{c} (both present in the second term of formula [9]).

Therefore, this leads to:

$${D}_{c}^{( n )} = \frac{\begin{matrix}{V}_{OUT}^{( n + 1 )} - \\ {V}_{OUT}^{( n )} \cdot [ 1 - \frac{{T}^{( n )}}{{R}_{L} \cdot {C}_{1}} - \frac{{( {T}^{( n )} )}^{2}}{2 \cdot {L}_{1} \cdot {C}_{1}} ] - {I}_{1}^{( n )} \cdot \frac{{T}^{( n )}}{{C}_{1}}\end{matrix}}{\frac{{V}_{cc} \cdot {( {T}^{( n )} )}^{2}}{{L}_{1} \cdot {C}_{1}} \cdot ( 1 - \frac{{D}_{c}^{( n - 1 )}}{2} )} \qquad [ 10 ]$$

Formula [10] is the one which allows to obtain the duty cycle D_{c} to be realized at cycle “n” to obtain the voltage V_{OUT}⁽ⁿ⁺¹⁾, with the values V_{OUT}⁽ⁿ⁾, I₁⁽ⁿ⁾ and D_{c}⁽ⁿ⁻¹⁾ being known.

The logic control unit UC must therefore calculate, at each cycle, the following pair of formulae, and specifically formula [11] first followed by formula [12]:

$$\begin{matrix}{D}_{c}^{( n )} = \frac{\begin{matrix}{V}_{OUT}^{( n + 1 )} - \\ {V}_{OUT}^{( n )} \cdot [ 1 - \frac{{T}^{( n )}}{{R}_{L} \cdot {C}_{1}} - \frac{{( {T}^{( n )} )}^{2}}{2 \cdot {L}_{1} \cdot {C}_{1}} ] - {I}_{1}^{( n )} \cdot \frac{{T}^{( n )}}{{C}_{1}}\end{matrix}}{\frac{{V}_{cc} \cdot {( {T}^{( n )} )}^{2}}{{L}_{1} \cdot {C}_{1}} \cdot ( 1 - \frac{{D}_{c}^{( n - 1 )}}{2} )} & [ 11 ] \\ {I}_{1}^{( n + 1 )} = {I}_{1}^{( n )} + \frac{{V}_{cc} \cdot {T}^{( n )}}{{L}_{1}} \cdot {D}_{c}^{( n )} - \frac{{V}_{OUT}^{( n )}}{{L}_{1}} \cdot {T}^{( n )} \\ if {I}_{1}^{( n + 1 )} < 0 ⇒ {I}_{1}^{( n + 1 )} = 0 & [ 12 ]\end{matrix}$$

Considering that the current I₁ cannot reverse its direction, formula [12] must be saturated at zero, i.e.: if I₁⁽ⁿ⁺¹⁾<0=>I₁⁽ⁿ⁺1)=0

The result of formula [11], however, may be positive or negative, but a negative duty cycle does not have any physical meaning. In that case, the model is indicating that to reach the target voltage V_{OUT}⁽ⁿ⁺¹⁾, charge would need to be taken away from C₁, and this can be achieved by setting D_{c}=0 and Dₛ>0.

Formulae [8] and [9] of the model, in that case, will continue to be valid, setting D_{c}⁽ⁿ⁾=0 and with the addition of a quantity of charge Qₛ⁽ⁿ⁾ which must be removed from C₁; therefore, it is:

$$\begin{matrix}{I}_{1}^{( n + 1 )} = {I}_{1}^{( n )} - \frac{{V}_{OUT}^{( n )}}{{L}_{1}} \cdot {T}^{( n )} & [ 13 ] \\ {V}_{OUT}^{( n + 1 )} = {V}_{OUT}^{( n )} \cdot [ 1 - \frac{{T}^{( n )}}{{R}_{L} \cdot {C}_{1}} - \frac{{( {T}^{( n )} )}^{2}}{2 \cdot {L}_{1} \cdot {C}_{1}} ] + {I}_{1}^{( n )} \cdot \frac{{T}^{( n )}}{{C}_{1}} - \frac{{Q}_{s}^{( n )}}{{C}_{1}} & [ 14 ]\end{matrix}$$

In the cycle in question, the charge Qₛ⁽ⁿ⁾ to be removed from C₁ to obtain V_{OUT}⁽ⁿ⁺¹⁾ can therefore be calculated as:

$${Q}_{s}^{( n )} = - {C}_{1} \cdot [ \begin{matrix}{V}_{OUT}^{( n + 1 )} - {V}_{OUT}^{( n )} \cdot \\ ( 1 - \frac{{T}^{( n )}}{{R}_{L} \cdot {C}_{1}} - \frac{{( {T}^{( n )} )}^{2}}{2 \cdot {L}_{1} \cdot {C}_{1}} ) \\ {I}_{1}^{( n )} \cdot \frac{{T}^{( n )}}{{C}_{1}}\end{matrix} - ] \qquad [ 15 ]$$

It is noted that formula [15], apart from the scale factor “−C₁”, corresponds to the numerator of formula [11] and therefore does not need to be recalculated. If therefore at cycle “n” the result is D_{c}<0, then D_{c}=0 must be imposed and the charge to be removed from the capacitor C₁ must be calculated on the basis of formula [15] (which charge is definitely positive since the denominator of formula [11] is definitely positive).

At this point, by also exploiting the fifth assumption previously mentioned, the duty cycle Dₛ(n) may be calculated from the charge Qₛ(n) (refer to FIG. 5 for a better understanding).

$$\begin{matrix}{I}_{2}^{pk} = \frac{{V}_{OUT}^{( n )} + {V}_{dd}}{{L}_{2}} \cdot {D}_{s}^{( n )} \cdot {T}^{( n )} & [ 16 ] \\ {I}_{2}^{pk} = \frac{{V}_{cc} - {V}_{OUT}^{( n )}}{{L}_{2}} \cdot ( {D}_{OFF}^{( n )} - {D}_{s}^{( n )} ) \cdot {T}^{( n )} & [ 17 ]\end{matrix}$$

By equalizing formulae [16] and [17], the instant at which the current I₂ returns to zero can be calculated, corresponding to D_{OFF}⁽ⁿ⁾ T⁽ⁿ⁾:

$${D}_{OFF}^{( n )} = {D}_{s}^{( n )} \cdot \frac{{V}_{cc} + {V}_{dd}}{{V}_{cc} - {V}_{OUT}^{( n )}}$$

The constraint imposed by the fifth assumption previously mentioned is reflected in the maximum value of D_{OFF}⁽ⁿ⁾, which must be equal to 1. It follows that Dₛ⁽ⁿ⁾ cannot exceed a certain value which we will indicate D_{sMAX}⁽ⁿ⁾:

$${D}_{sMAX}^{( n )} = \frac{{V}_{cc} - {V}_{OUT}^{( n )}}{{V}_{cc} + {V}_{dd}} \qquad [ 18 ]$$

Qₛ⁽ⁿ⁾ can now be calculated as a function of Dₛ⁽ⁿ⁾:

$$\begin{matrix}{Q}_{s}^{( n )} = \frac{{I}_{2}^{pk} \cdot {D}_{OFF}^{( n )} \cdot {T}^{( n )}}{2} \\ = \frac{( {V}_{OUT}^{( n )} + {V}_{dd} )}{{L}_{2}} \cdot \frac{{( {T}^{( n )} )}^{2}}{2} \cdot \frac{( {V}_{cc} + {V}_{dd} )}{( {V}_{cc} - {V}_{OUT}^{( n )} )} \cdot {( {D}_{s}^{( n )} )}^{2}\end{matrix} \qquad [ 19 ]$$

By equalizing formulae [15] and [19] and expressing Dₛ⁽ⁿ⁾, we obtain:

$${D}_{s}^{( n )} = \sqrt{\begin{matrix}\frac{2 \cdot {L}_{2} \cdot {C}_{1}}{{( {T}^{( n )} )}^{2} \cdot ( {V}_{cc} + {V}_{dd} )} \cdot \\ \begin{matrix}[ \begin{matrix}- {V}_{OUT}^{( n + 1 )} + {V}_{OUT}^{( n )} \cdot \\ ( 1 - \frac{{T}^{( n )}}{{R}_{L} \cdot {C}_{1}} - \frac{{( {T}^{( n )} )}^{2}}{2 \cdot {L}_{1} \cdot {C}_{1}} ) + {I}_{1}^{( n )} \cdot \frac{{T}^{( n )}}{{C}_{1}}\end{matrix} ] \cdot \\ \frac{( {V}_{cc} - {V}_{OUT}^{( n )} )}{( {V}_{dd} + {V}_{OUT}^{( n )} )}\end{matrix}\end{matrix}} \qquad [ 20 ]$$

In conclusion, the algorithm for calculating D_{c}⁽ⁿ⁾ and Dₛ⁽ⁿ⁾ is as follows.

### Step 1 (First Method):

$${N}^{( n )} = {V}_{OUT}^{( n + 1 )} - {V}_{OUT}^{( n )} \cdot [ 1 - \frac{{T}^{( n )}}{{R}_{L}^{( n )} \cdot {C}_{1}} - \frac{{( {T}^{( n )} )}^{2}}{2 \cdot {L}_{1} \cdot {C}_{1}} ] - {I}_{1}^{( n )} \cdot \frac{{T}^{( n )}}{{C}_{1}} \qquad [ 21 ]$$

### Step 2 (First Method):

$$\begin{matrix}If {N}^{( n )} \geq 0 \\ {D}_{c}^{( n )} = \frac{{N}^{( n )}}{\frac{{V}_{cc} \cdot {( {T}^{( n )} )}^{2}}{{L}_{1} \cdot {C}_{1}} \cdot ( 1 - \frac{{D}_{c}^{( n - 1 )}}{2} )} \\ {D}_{s}^{( n )} = 0 & [ 22 ] \\ If {N}^{( n )} < 0 \\ {D}_{c}^{( n )} = 0 \\ {D}_{s}^{( n )} = \sqrt{\frac{2 \cdot {L}_{2} \cdot {C}_{1}}{{( {T}^{( n )} )}^{2} \cdot ( {V}_{cc} + {V}_{dd} )} \cdot ( - {N}^{( n )} ) \cdot \frac{( {V}_{cc} - {V}_{OUT}^{( n )} )}{( {V}_{dd} + {V}_{OUT}^{( n )} )}} & [ 23 ]\end{matrix}$$

where Dₛ⁽ⁿ⁾ must be limited to D_{sMAX}⁽ⁿ⁾ according to [18].

### Step 3 (First Method):

$${I}_{c} = {I}_{1}^{( n )} + \frac{{V}_{cc} \cdot {T}^{( n )}}{{L}_{1}} \cdot {D}_{c}^{( n )} - \frac{{V}_{OUT}^{( n )}}{{L}_{1}} \cdot {T}^{( n )} \qquad [ 24 ]$$

### Step 4 (First Method):

if I_{c}≧0=≧I₁⁽ⁿ⁺¹⁾=I_{c};

if I_{c}0<0=≧I₁⁽ⁿ⁺¹⁾=0.

Formula [23] is the most difficult to be calculated by dedicated logic circuitry, because of the presence of the term (V_{cc}−V_{OUT}⁽ⁿ⁾)/(V_{dd}+V_{OUT}⁽ⁿ⁾) and because of the square root.

Given that the discharge (and therefore the calculation of formula [23]) takes place normally when V_{OUT}⁽ⁿ⁾ is small, the following approximation can be applied:

$$( \frac{{V}_{cc} - {V}_{OUT}^{( n )}}{{V}_{dd} + {V}_{OUT}^{( n )}} ) \approx \frac{{V}_{cc}}{{V}_{dd}} - \frac{( {V}_{cc} + {V}_{dd} )}{{V}_{dd}^{2}} \cdot {V}_{OUT}^{( n )} \qquad [ 25 ]$$

A second control method is based on the analytical model of formulae [8] and [9], but instead of obtaining I₁⁽ⁿ⁾ from the model and assuming that the V_{OUT}⁽ⁿ⁾ requested is actually that obtained, it measures these two quantities.

The simplified diagram of the associated converter is shown in FIG. 6; this differs from the diagram of FIG. 2 by the addition of two circuit components ADC, analogue-to-digital converters, to carry out the measurements.

This second method exhibits the following advantages:
lower complexity in the algorithm since the calculations related to steps 3 and 4 illustrated previously are avoided,
possibility of including protective measures against excess currents or excess voltages,
more accurate control during the start transient, when the current I₁ of the model is not stable enough yet.

Naturally, it is necessary to provide the circuitry needed to measure the abovementioned quantities.

The idea is to make use of the measured quantities not for a closed loop control in the conventional sense, but as initial values for cycle “n” in order to calculate, by means of the model, the duty cycle.

With \tilde{V}_{OUT}⁽ⁿ⁾ and Ĩ₁⁽ⁿ⁾ used to indicate the measurements, the algorithm will turn out to be made up simply of the following two steps:

### Step 1 (Second Method):

$${N}^{( n )} = {V}_{OUT}^{( n + 1 )} - {\tilde{V}}_{OUT}^{( n )} \cdot [ 1 - \frac{{T}^{( n )}}{{R}_{L}^{( n )} \cdot {C}_{1}} - \frac{{( {T}^{( n )} )}^{2}}{2 \cdot {L}_{1} \cdot {C}_{1}} ] - {\tilde{I}}_{1}^{( n )} \cdot \frac{{T}^{( n )}}{{C}_{1}} \qquad [ 26 ]$$

where V_{OUT}⁽ⁿ⁺¹⁾ is the next value of the output voltage as a consequence of the input A(t).

### Step 2 (Second Method):

$$\begin{matrix}If {N}^{( n )} \geq 0 \\ {D}_{c}^{( n )} = \frac{{N}^{( n )}}{\frac{{V}_{cc} \cdot {( {T}^{( n )} )}^{2}}{{L}_{1} \cdot {C}_{1}} \cdot ( 1 - \frac{{D}_{c}^{( n - 1 )}}{2} )} \\ {D}_{s}^{( n )} = 0 & [ 27 ] \\ If {N}^{( n )} < 0 \\ {D}_{c}^{( n )} = 0 \\ {D}_{s}^{( n )} = \sqrt{\frac{2 \cdot {L}_{2} \cdot {C}_{1}}{{( {T}^{( n )} )}^{2} \cdot ( {V}_{cc} + {V}_{dd} )} \cdot ( - {N}^{( n )} ) \cdot \frac{( {V}_{cc} - {V}_{OUT}^{( n )} )}{( {V}_{dd} + {V}_{OUT}^{( n )} )}} & [ 28 ]\end{matrix}$$

where Dₛ⁽ⁿ⁾ must be limited to D_{sMAX}⁽ⁿ⁾ according to [18].

A third control method is based on the analytical model of formulae [8] and [9], but it needs the measurement of the output voltage V_{OUT} and the determination of the load applied at the output, in particular the actual value of the resistive load R_{L}.

In the example of FIG. 7, the load is determined by measuring the output current Iₒ; the ratio between the measured value of the voltage V_{OUT} and the measured value of the current I₀ corresponds to the resistance value of the load.

The load can be determined in other ways, for example by measuring the power transferred to the load or by measuring the converter input current and estimating the output of the converter.

A simplified diagram of a converter based on this method is shown in FIG. 7; this differs from the diagram of FIG. 2 by the addition of two circuit components ADC, analogue-to-digital converters, to carry out the measurements.

The true resistance of the power amplifier, in particular of its output stage, can therefore be worked out (cycle by cycle, if this is desired) and the said value (or an average value thereof) can be used at the next cycle to precisely calculate the duty cycle needed to obtain the desired power.

With \tilde{V}_{OUT}⁽ⁿ⁾ and Ĩ_{O}⁽ⁿ⁾ used to indicate the measurements, the algorithm will turn out to be made up of the following steps:

### Step 1 (Third Method):

$${N}^{( n )} = {V}_{OUT}^{( n + 1 )} - {\tilde{V}}_{OUT}^{( n )} \cdot [ 1 - \frac{{T}^{( n )}}{{\tilde{R}}_{L}^{( n )} \cdot {C}_{1}} - \frac{{( {T}^{( n )} )}^{2}}{2 \cdot {L}_{1} \cdot {C}_{1}} ] - {I}_{1}^{( n )} \cdot \frac{{T}^{( n )}}{{C}_{1}} \qquad [ 29 ]$$

where V_{OUT}⁽ⁿ⁺¹⁾ is the next value of the output voltage as a consequence of the input A(t); I₁⁽ⁿ⁾ is the value of the current through the inductor L₁ calculated using the model; \tilde{R}_{L}⁽ⁿ⁾=\tilde{V}_{OUT}⁽ⁿ⁾/Ĩ_{O}⁽ⁿ⁾ is the resistive load that the power amplifier presents at the supply port.

### Step 2 (Third Method):

$$\begin{matrix}If {N}^{( n )} \geq 0 \\ {D}_{c}^{( n )} = \frac{{N}^{( n )}}{\frac{{V}_{cc} \cdot {( {T}^{( n )} )}^{2}}{{L}_{1} \cdot {C}_{1}} \cdot ( 1 - \frac{{D}_{c}^{( n - 1 )}}{2} )} \\ {D}_{s}^{( n )} = 0 & [ 30 ] \\ If {N}^{( n )} < 0 \\ {D}_{c}^{( n )} = 0 \\ {D}_{s}^{( n )} = \sqrt{\frac{2 \cdot {L}_{2} \cdot {C}_{1}}{{( {T}^{( n )} )}^{2} \cdot ( {V}_{cc} + {V}_{dd} )} \cdot ( - {N}^{( n )} ) \cdot \frac{( {V}_{cc} - {V}_{OUT}^{( n )} )}{( {V}_{dd} + {V}_{OUT}^{( n )} )}} & [ 31 ]\end{matrix}$$

where Dₛ⁽ⁿ⁾ must be limited to D_{sMAX}⁽ⁿ⁾ according to [18].

### Step 3 (Third Method):

$${I}_{c} = {I}_{1}^{( n )} + \frac{{V}_{cc} \cdot {T}^{( n )}}{{L}_{1}} \cdot {D}_{c}^{( n )} - \frac{{\tilde{V}}_{OUT}^{( n )}}{{L}_{1}} \cdot {T}^{( n )} \qquad [ 32 ]$$

### Step 4 (Third Method):

if I_{c}≧0=>I₁⁽ⁿ⁺¹⁾I_{c};

if I_{c}<0=>I₁⁽ⁿ⁺¹⁾=0.

The diagrams of FIG. 2, FIG. 6 and FIG. 7 are fairly complete, but simplified; for example, the MOSFET transistor driver circuits are not elaborated; also, for example, the circuitry that generates the voltage signals to be sent to the circuit components ADC is represented only in an indicative manner: in the case of determination of a voltage signal, it is reduced to a single wire, while in the case of determination of a current signal it is reduced to a resistor, namely the resistor Rs.

In practice, for example, it will be necessary to include circuits for adapting the voltage signal to be sampled to the dynamic range of the analogue input voltage of the specific circuit components ADC chosen; in the case of detecting the current signal, a suitable current-voltage converter must be chosen.

Furthermore, the signals detected must be suitably filtered (anti-aliasing filter) so as not to allow the harmonics and other frequencies, outside the band of the circuit components ADC, to be sampled.

Finally, a clock signal must be supplied to the circuit components ADC, at the desired sampling frequency.

It is worth noting that, in these diagrams, both the PWM converters are connected directly to each other; however, one cannot rule out that this connection might be made indirectly via other circuit components not represented in these diagrams.

For completeness, a list of components that can be used in these circuits is set out below in table form.

| Circuit | | Component |
|---|---|---|
| component | Manufacturer | identification |
| M1 | INTERNATIONAL RECTIFIER | IRLR9343 |
| D1 | INTERNATIONAL RECTIFIER | 50WQ10FN |
| L1 | PULSE ENGINEERING | PE-54044S |
| C1 | TERN MURATA MANUFACTURING | 3 × 330 nF |
| | | in parallel |
| M2 | INTERNATIONAL RECTIFIER | IRLR3105 |
| L2 | COILCRAFT | 4.7 uH |
| D2 | INTERNATIONAL RECTIFIER | 50WQ10FN |
| UC | XILINX | XC2S150E + |
| | UNITRODE | UC2715 |
| ADC | ANALOG DEVICES | AD7894 |

Clearly, various modifications can be introduced to that which has been described and illustrated, by way of example, and the means or materials described can be replaced by equivalent means or materials without consequently departing from the claimed scope of protection.

1. Power converter adapted to be connected to an electrical power source, in particular a voltage source (V_{cc}), and adapted to receive at its input a control signal (A(t)) for the conversion, including a first regulator circuit (L₁, C₁, M₁, D₁) of the pulse width modulation step-down type, characterized in that it includes an energy recovery circuit.

2. Power converter according to claim 1, characterized in that the said energy recovery circuit includes a second regulator circuit (L₂, M₂, D₂) of the pulse width modulation step-up type.

3. Power converter according to claim 2, in which the input of the said second regulator circuit (L₂, M₂, D₂) is connected to the output of the said first regulator circuit (L₁, C₁, M₁, D₁) and in which the output of the said second regulator circuit (L₂, M₂, D₂) is connected to the input of the said first regulator circuit (L₁, C₁, M₁, D₁).

4. Power converter according to claim 1 or 2 or 3, characterized in that it includes filter means (F) connected downstream of the said first regulator circuit (L₁, C₁, M₁, D₁) and adapted to filter out the switching noise.

5. Power converter according to claim 4, characterized in that the said filter means (F) comprise a multiple notch filter.

6. Power converter according to one of the preceding claims, characterized in that the said energy recovery circuit is adapted to quickly discharge energy-storing circuit components (L₁, C₁) of the said first regulator circuit (L₁, C₁, M₁, D₁).

7. Power converter according to one of the preceding claims, characterized in that the said first regulator circuit (L₁, C₁, M₁, D₁) is adapted to be connected to a positive voltage source (V_{cc}) and that the said second regulator circuit (L₂, M₂, D₂) is adapted to be connected to a negative voltage source (V_{dd}), so as to quickly discharge energy-storing circuit components (L₁, C₁) of the said first regulator circuit (L₁, C₁, M₁, D₁).

8. Power converter according to one of the preceding claims, characterized in that it includes a control unit (UC) for switching circuit components (M₁, M₂) of the said first regulator circuit (L₁, C₁, M₁, D₁) and/or of the said second regulator circuit (L₂, M₂, D₂), adapted to receive at its input the said control signal (A(t)) and to control the switching of the said switching circuit components (M₁, M₂) in relation to the said control signal (A(t)).

9. Power converter according to claim 8, characterized in that the said control unit (UC) is adapted to operate according to a control method, preferably based on an analytical model of the said first regulator circuit (L₁, C₁, M₁, D₁.

10. Power converter according to claim 8, characterized in that it includes means (ADC) adapted to determine at least some of the state variables (I₁, Vₒ) of the said first regulator circuit (L₁, C₁, M₁, D₁), and in that the said control unit (UC) is connected to the said determination means (ADC) and is adapted to operate according to a control method that takes into account the values of the state variables (I₁, Vₛ) determined, the said control method preferably being based on an analytical model of the said first regulator circuit (L₁, C₁, M₁, D₁).

11. Power converter according to claim 8, characterized in that it includes determination means (ADC) adapted to detect the output voltage (Vₒᵤₜ) at the converter and the load (R_{L}) applied at the output of the converter, and in which the said control unit (UC) is connected to the said determination means (ADC) and is adapted to operate according to a control method that takes into account the output voltage (Vₒᵤₜ) determined and the load on the output (R_{L}) determined, the said control method preferably being based on an analytical model of the said first regulator circuit (L₁, C₁, M₁, D₁).

12. Power converter according to claim 11, in which the said determination means (ADC) are adapted to measure the output voltage (Vₒᵤₜ) at the converter and the output current (Iₒ) at the converter.

13. Power converter according to one of claims 8 to 12, in which the said control unit (UC) sets the width (D_{c}, Dₛ) of the switching pulses periodically, preferably at each switching cycle.

14. Power converter according to claim 13, characterized in that the said control unit (UC) sets the width (D_{c}, Dₛ) of the switching pulses also in relation to the previous state at least of the said first regulator circuit (L₁, C₁, M₁, D₁), in particular the state at the previous switching cycle.

15. Power converter according to one of claims 8 to 14, characterized in that the said control unit (UC) is adapted to apply a random and variable time-domain jitter to the switching of the said switching circuit components.

16. Power converter according to one of the preceding claims, characterized in that it is adapted to power any type of load or actuator.

17. Amplitude modulator adapted to receive at the input a modulating signal and including an amplifier, preferably in class AB, B, C, D, E or F, and a power supplier adapted to supply power, characterized in that the said power supplier includes a power converter according to one of the preceding claims in which its control signal for the conversion corresponds to the said modulating signal.

18. Radio transmitter including an amplitude modulator according to the preceding claim.
